(19) United States
(12) Patent Application Publication
(10) Pub. No.: US 2025/0021834 A1
(43) Pub. Date: Jan. 16, 2025

(54) ARTIFICIAL INTELLIGENCE SYSTEM FOR GENERATING ACTION TENDENCY CONSIDERING EMOTION AND MOOD ACCORDING TO EXTERNAL INFORMATION RECOGNITION AND METHOD THEREOF

(71) Applicant: KOREA INSTITUTE OF SCIENCE AND TECHNOLOGY, Seoul (KR)

(72) Inventors: SungKee PARK, Seoul (KR); JungGyu HWANG, Seoul (KR)

(73) Assignee: KOREA INSTITUTE OF SCIENCE AND TECHNOLOGY, Seoul (KR)

(21) Appl. No.: 18/493,236

(22) Filed: Oct. 24, 2023

(30) Foreign Application Priority Data
Jul. 14, 2023 (KR) 10-2023-0091857

(51) Int. Cl. G06N 5/022

(52) U.S. Cl. CPC G06N 5/022

(57) ABSTRACT

An artificial intelligence system and a method for generating action tendency by considering emotion and mood according to recognition of external information include generating primary emotion and mood based on external information of the artificial intelligence system and a preset nature data, generating secondary emotion based on the generated mood, and generating action tendency for suggesting a direction of action decision of the artificial intelligence system based on the generated secondary emotion, and accordingly, an artificial intelligence system capable of smooth and natural interaction with people may be provided.

### CROSS-REFERENCE TO RELATED APPLICATION

This application is based on and claims priority under 35 U.S.C. § 119 to Korean Patent Application No. 10-2023-0091857, filed on Jul. 14, 2023, in the Korean Intellectual Property Office, the disclosure of which is incorporated by reference herein in its entirety.

### BACKGROUND

The present disclosure relates to an artificial intelligence system that generates emotions based on recognition of external information and a method of the artificial intelligence system.

Artificial intelligence is a field of technology that implements human cognitive, reasoning, and determination abilities through computers, and artificial intelligence systems, which generate emotion for a smooth interaction with people, are attracting attention. Most existing artificial intelligence systems generate and express emotion in a short term according to external stimuli and events input to the artificial intelligence systems. However, the emotion is generated without considering nature or mood like humans, and accordingly, an interaction between artificial intelligence systems and people is awkward and unnatural.

Korea Patent No. 10-1239732 titled “Method for Generating Emotion of an Artificial Intelligent System and Artificial Intelligent System” discloses an artificial intelligence system that converts external stimulus into mental energy and physical energy, introduces concept of entropy and homeostasis, feeds back energy, and then generates emotion by mapping to a circular model. However, the related art also generates emotion without considering nature or mood, and accordingly, an interaction between an artificial intelligence system and people is awkward and unnatural.

### SUMMARY

An artificial intelligence system that enables a smooth and natural interaction with people by enabling expressions of emotion and an action to which nature and mood are reflected, and a method therefor. Technical objects of the present disclosure are not limited to the technical objects described above, and another technical object may be derived from the following description.

According to an aspect of the present disclosure, an artificial intelligence system that generates an action tendency by considering emotion and mood according to recognition of external information includes an external information recognition unit configured to recognize external information of the artificial intelligence system, a basic emotion generation unit configured to generates primary emotion and mood based on the recognized external information and a preset nature data of the artificial intelligence system, a secondary emotion generation unit configured to generate secondary emotion based on the generated mood, and an action tendency generation unit configured to generate action tendency for suggesting a direction of action decision of the artificial intelligence system based on the generated secondary emotion.

The basic emotion generation unit may generate the mood by modeling one mood group among a plurality of mood groups based on the recognized external information and pleasure arousal dominance (PAD) values indicating nature of the artificial intelligence system.

The secondary emotion generation unit may generate the secondary emotion based on the recognized external information, the generated mood, and a preset social norm of the artificial intelligence system.

The secondary emotion generation unit may calculate intensity of secondary emotion of each type based on an increment of at least one type of secondary emotion generated according to a suitability evaluation result of an action of a user for the preset social norm and intensity of each mood group matching the secondary emotion of each type among intensities of the generated mood, and generates the secondary emotion by determining secondary emotion of a highest intensity among a plurality of types of secondary emotion as the secondary emotion.

The artificial intelligence system may further include a task generation unit configured to generate at least one task based on the action tendency generated by the action tendency generation unit, wherein the secondary emotion generation unit may calculate the intensity of the secondary emotion of each type based on an increment of at least one type of secondary emotion generated according to the suitability evaluation result of the action of the user for the preset social norm and relevance evaluation of the action of the user for the generated task and based on the intensity of each mood group matching the secondary emotion of each type among the intensities of the generated mood, and generate the secondary emotion by determining secondary emotion of a highest intensity among a plurality of types of secondary emotion as the secondary emotion.

The basic emotion generation unit may generate the mood by modeling the one mood group among the plurality of mood groups based on external background feeling, the pleasure arousal dominance (PAD) values indicating the nature, and the generated secondary emotion among the recognized external information.

The basic emotion generation unit may select one of the plurality of mood groups according to whether each of a “P” value, an “A” value, and a “D” value of the pleasure arousal dominance (PAD) values indicating the nature corresponds to a positive number or a negative number, and model the selected mood group based on the external background feeling of the recognized external information, the pleasure arousal dominance (PAD) values indicating the nature, and the generated secondary emotion.

The basic emotion generation unit may model the selected mood group by calculating intensity of the selected mood group based on the pleasure arousal dominance (PAD) values indicating the nature, a plurality of values determined according to the external background feeling of the recognized external information, and an accumulated value of the number of feedbacks of at least one piece of secondary emotion associated with the selected mood group.

The basic emotion generation unit may generate primary emotion by modeling at least one emotional element among a plurality of emotional elements based on external physical stimulus of the recognized external information and pleasure arousal dominance (PAD) values indicating the nature.

The action tendency generation unit may generate action tendency of the artificial intelligence system based on the generated secondary emotion and a preset action goal of the artificial intelligence system.

According to another aspect of the present disclosure, a method of generating action tendency by considering emotion and mood according to recognition of external information includes recognizing external information of an artificial intelligence system, generating primary emotion and mood based on the recognized external information and a preset nature data of the artificial intelligence system, generating secondary emotion based on the generated mood, and generating action tendency for suggesting a direction of action decision of the artificial intelligence system based on the generated secondary emotion.

According to another aspect of the present disclosure, a computer-readable recording medium in which a program for causing a computer to perform the method of generating action tendency by considering emotion and mood according to recognition of external information is recorded.

The present disclosure is not limited to the effects described above, and other effects may be derived from following description.

### BRIEF DESCRIPTION OF THE DRAWINGS

Embodiments of the inventive concept will be more clearly understood from the following detailed description taken in conjunction with the accompanying drawings in which:

FIG. 1 is a configuration diagram of an artificial intelligence system according to an embodiment of the present disclosure;

FIG. 2 is a flowchart of a method of generating an action tendency according to an embodiment of the present disclosure;

FIG. 3 is a table showing factors that affect generation of mood by a basic emotion generation unit 20 illustrated in FIG. 1;

FIG. 4 is a table showing factors that affect generation of secondary emotion by secondary emotion generation unit 30 illustrated in FIG. 1;

FIG. 5 illustrates examples of generating secondary emotion by using the secondary emotion generation unit 30 illustrated in FIG. 1;

FIG. 6 is a flowchart of a secondary emotion generation process by the secondary emotion generation unit 30 illustrated in FIG. 1;

FIG. 7 is an example diagram of a secondary-emotion model generated according to the secondary emotion generation process illustrated in FIG. 6; and

FIG. 8 is a table showing a correspondence between secondary emotions and an action tendency of an artificial intelligence system.

### DETAILED DESCRIPTION OF THE EMBODIMENTS

Hereinafter, embodiments of the present disclosure will be described in detail with reference to the drawings. Embodiments of the present disclosure to be described below relate to an artificial intelligence system that enables a smooth and natural interaction with people by enabling expressions of emotion and an action to which nature and mood are reflected, and a method therefor. Hereinafter, the artificial intelligence systems and the method will be briefly referred to as an “artificial intelligence system” and an “action tendency generating method”.

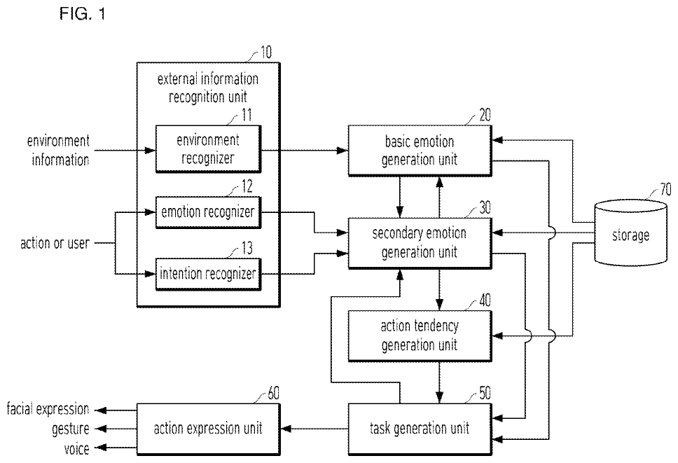

FIG. 1 is a configuration diagram of an artificial intelligence system according to an embodiment of the present disclosure. Referring to FIG. 1, the artificial intelligence system according to the embodiment includes an external information recognition unit 10, a basic emotion generation unit 20, a secondary emotion generation unit 30, an action tendency generation unit 40, a task generation unit 50, an action expression unit 60, and a storage 70. Those skilled in the technical field to which the present embodiment belongs will understand that components may also be implemented as hardware for providing specific functions or may also be implemented as a combination of a memory in which software for providing specific functions is recorded, a processor, a bus, and so on. The artificial intelligence system according to the present embodiment may also be applied to robots, or may also be applied to artificial humans, such as virtual reality, augmented reality, and chatbots. In this way, the artificial intelligence system according to the present embodiment may be applied to various fields.

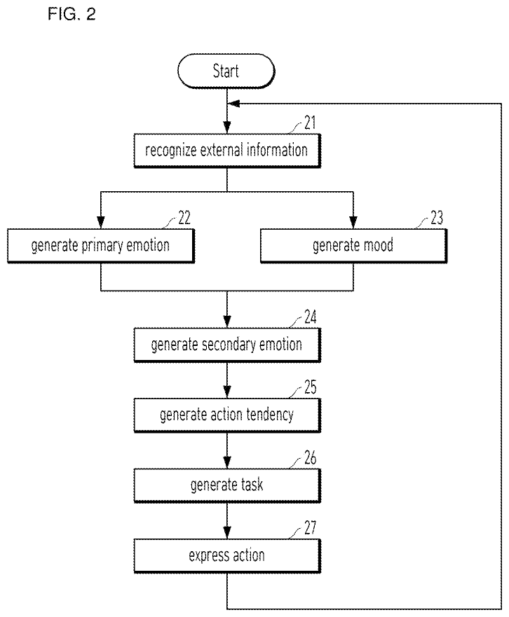

FIG. 2 is a flowchart of a method of generating an action tendency, according to an embodiment of the present disclosure. Referring to FIG. 2, the method of generating an action tendency according to the present embodiment consists of the following steps performed by the artificial intelligence system illustrated in FIG. 1. Hereinafter, the artificial intelligence system illustrated in FIG. 1 will be described in detail with reference to FIG. 2.

In step 21, the external information recognition unit 10 recognizes external information of the artificial intelligence system illustrated in FIG. 1 by using various sensors, such as a camera and a microphone. The external information recognition unit 10 includes an environment recognizer 11, an emotion recognizer 12, and an intention recognizer 13. The environment recognizer 11 recognizes environmental information outside the artificial intelligence system illustrated in FIG. 1. For example, the environment recognizer 11 may recognize environmental information, such as date, time, and sound of a space at which the artificial intelligence system illustrated in FIG. 1 is located. Mood and emotion of the artificial intelligence system may be generated based on information on season according to a specific date, a holiday, a weekday, and an anniversary, information on brightness of day or night according to a specific time, information on a level of ambient noise, and so on.

The emotion recognizer 12 recognizes an action of a user that indicates an emotional state of the user facing the artificial intelligence system illustrated in FIG. 1. For example, the emotion recognizer 12 may recognize a user's facial expression as the emotional state of the user and may recognize the tone of speech in addition to the user's facial expression. The intent recognizer 13 recognizes an action of a user indicating the intent of the user facing the artificial intelligence system illustrated in FIG. 1. For example, the emotion recognizer 12 may recognize a user's intention based on the content of the user's speech and action pattern.

For example, when a user located around the artificial intelligence system illustrated in FIG. 1 says “Robot, bring me some water”, the emotion recognizer 12 may recognize the user's intention to run an errand. When a user located around the artificial intelligence system illustrated in FIG. 1 makes a call action with a hand gesture, the emotion recognizer 12 may recognize the user's intention to indicate an approach. The external information recognition unit 10, the emotion recognizer 12, and the intention recognizer 13 may be implemented by using a human neural network. For example, the intent recognizer 13 may be implemented by using bidirectional encoder representations from transformers (BERT).

In step 22 and step 23, the basic emotion generation unit 20 generates primary emotion and mood based on the external information recognized by the external information recognition unit 10 in step 21, nature data of a preset artificial intelligence system, and the secondary emotion generated by the action tendency generation unit 40 in step 25. When power is input to the artificial intelligence system and step 21 to step 27 illustrated in FIG. 2 are performed first, the secondary emotion generated by the action tendency generation unit 40 does not exist, and accordingly, the basic emotion generation unit 20 generates primary emotion and mood based on the external information recognized by the external information recognition unit 10 in step 21 and nature data of a preset artificial intelligence system.

Nature of the artificial intelligence system illustrated in FIG. 1 is defined as a Big5 model proposed by “Lewis R. Golberg”. That is, the nature of the artificial intelligence system illustrated in FIG. 1 may be defined by setting a specific value between −1 and 1 to each of five factors: O (openness), C (conscientiousness), E (extraversion), A (agreeableness), and N (neuroticism) according to the Big5 model. In this way, nature data defined according to the Big5 model is stored in the storage 70 as five-dimensional data of OCEAN.

The basic emotion generation unit 20 converts an OCEAN value, which is five-dimensional data stored in the storage 70, into pleasure arousal dominance (PAD) values, which are three-dimensional data, according to Equation 1 below, and generates primary emotion and mood based on the converted PAD values and the external information recognized by the external information recognition unit 10. In Equation 1, “P” means pleasure, “A” means arousal, and “D” means dominance. The intensity of each of three factors, P (pleasure), A (arousal), and D (dominance), is set to a specific value between −1 and 1. The PAD model was proposed by “Albert Mehrabian”.

$$P = 0.21 * E + 0.59 * A + 0.19 * N \\ A = 0.15 * O + 0.3 * A - 0.57 * N \\ D = 0.25 * O + 0.17 * C + 0.6 * E - 0.32 * A \qquad Equation 1$$

In step 22, the basic emotion generation unit 20 generates primary emotion by modeling at least one emotion element among a plurality of emotion elements based on external physical stimulus that does not require cognitive evaluation among pieces of the external environmental information recognized by the environment recognizer 11 of the external information recognition unit 10 and PAD values indicating the nature of the artificial intelligence system. Modeling of each emotional element may be made by setting values of each emotional element to indicate intensity of emotion corresponding to each emotional element. The basic emotion generation unit 20 reacts quickly to the external physical stimulus, such as external sound level and energy level, without cognitive evaluation and models emotional elements, such as fear and surprise.

For example, the basic emotion generation unit 20 may model the emotional element of surprise according to Equation 2 below when an external sound level in the external information recognized by the environment recognizer 11 is greater than multiplication of an arousal degree “V” of an artificial intelligence system by a sound threshold “th1 “. The external sound level may be detected by a microphone of a robot to which an artificial intelligence system is applied. The basic emotion generation unit 20 models the emotional element of fear according to Equation 2 below when an energy level of the artificial intelligence system in the external information recognized by the environment recognizer 11 is less than an energy threshold “th2” of the artificial intelligence system. The energy level of the artificial intelligence system may be detected by a battery management module of the robot to which the artificial intelligence system is applied.

$$E 1 ( t ) = \{ \begin{matrix}if sound level > ∇ \cdot th 1 , & then E 1 ( t ) = “ surprise ” \\ if energy level ( hungry ) < th 2 , & then E 1 ( t ) = “ afraid ”\end{matrix} \qquad Equation 2$$

In Equation 2, “E1(t)” means an emotional element, and “N” means an arousal degree of the artificial intelligence system. The arousal degree “N” is a value indicating how sensitive the artificial intelligence system is to external physical stimulus, and this value is determined by the “A” value of the PAD values indicating the nature of the artificial intelligence system. The value of “N” may be 1 when the “A” value is −1 and may be 0.5 when the “A” value is 1. For example, the more sensitive an artificial intelligence system is, the more artificial intelligence system responds to quieter sound. In this way, the primary emotion is generated in rapid response to an external physical stimulus without cognitive evaluation and is transferred to the task generation unit 50 in the form of an event rather than a temporal transition. Accordingly, the artificial intelligence system performs a predetermined task. For example, when the task generation unit 50 receives the emotional element of fear and information that the remaining battery power is low, the artificial intelligence system performs a battery charging task.

In step 23, the basic emotion generation unit 20 generates mood by modeling one of a plurality of mood groups based on external background feeling that does not require cognitive evaluation, PAD values indicating the nature of an artificial intelligence system, and secondary emotion generated by the secondary emotion generation unit 30 among pieces of the external environmental information recognized by the environment recognizer 11 of the external information recognition unit 10. Mood continuously affects the emotion of an artificial intelligence system without changing significantly depending on specific event and is shifted over a longer period of time than emotion. The basic emotion generation unit 20 reacts quickly to external background feeling, such as weather and time (day and night) without cognitive evaluation and models mood groups, such as joy, anticipation, and trust.

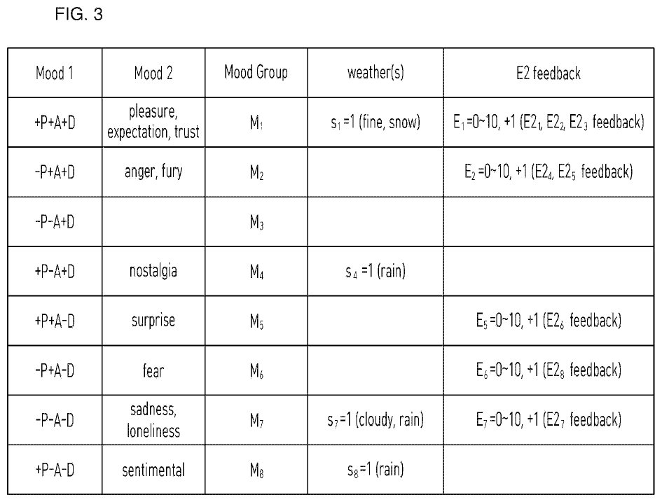

FIG. 3 is a table showing factors that affect mood generation by the basic emotion generation unit 20 illustrated in FIG. 1. The basic emotion generation unit 20 selects one of eight mood groups according to the table illustrated in FIG. 3 based on the PAD values indicating the nature of an artificial intelligence system. That is, the basic emotion generation unit 20 select one of the mood groups depending on whether each of a “P” value, an “A” value, or a “D” value of PAD values indicating the nature of the artificial intelligence system corresponds to a positive number or a negative number.

Referring to “Mood 1” and “Mood 2” in FIG. 3, the PAD values indicating the nature of the artificial intelligence system are mapped to any one of eight types of emotion in the eight models proposed by “Robert Plutchik” depending on whether each of the “P” value, the “A” value, and the “D” value corresponds to a positive number or a negative number. For example, when the “P” value of the nature of the artificial intelligence system is “+” and the “A” value is “+” and the “D” value is “+”, the mood of the artificial intelligence system is “+P+A+D”, and joy, anticipation, and trust in the eight types of emotion in the eight models are emphasized. The eight types of emotion in the eight models are modeled to consider paths that may mutually affect the mood of the artificial intelligence system and the secondary emotion.

The basic emotion generation unit 20 models the selected mood group as described above according to Equation 3 below based on the external background feeling, the PAD values indicating the nature of an artificial intelligence system, and the secondary emotion generated by the secondary emotion generation unit 30 among the external environment information recognized by the environment recognizer 11 of the external information recognition unit 10. In Equation 3, “Mᵢ(t)” indicates intensity of one of the mood groups M₁ to M₈ at time “t”. As described above, the mood of an artificial intelligence system has characteristics that are shifted over time.

$${M}_{i} ( t ) = {a}_{i} + ( {b}_{i} + ε \cdot {s}_{i} + γ \cdot {E}_{i} ) \cdot sin ( π \frac{\vert {c}_{p e a k} - σ + 12 \vert}{24} ) , t = 0 ∼ 24 \qquad Equation 3$$

In Equation 3, “aᵢ” becomes a specific value, for example, 0.1 only when corresponding to a mood group to which the nature of the artificial intelligence system belongs, and in all other case, “aᵢ” becomes 0. “bi” refers to an amplitude of mood that changes in proportion to an arousal degree of the nature of an artificial intelligence system, and is in the range of 0<b<1. “bᵢ” basically uses the “A” value among the PAD values and may change depending on an actual environment and situations. “ε” refers to a coefficient for an external environment, such as weather, and is in the range of 0<ε<1 in proportion to an arousal degree of the nature of an artificial intelligence system. “ε” basically uses the “A” value among the PAD values and may change depending on an actual environment and situations.

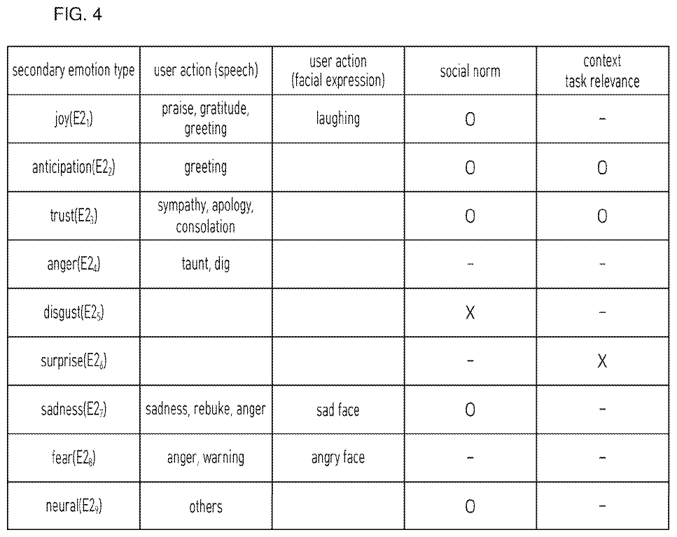

“sᵢ” refers to an element indicating an environment, such as weather, and affects an amplitude of mood “bi”. “sᵢ” becomes 0 or 1. In “sᵢ”, only the mood group corresponding to the conditions of the table illustrated in FIG. 4 becomes 1, and the others become 0. For example, when the weather is sunny or snowy, a value of “s₁” of a mood group “M₁” (joy, anticipation, and trust) is 1, and the other values of “sᵢ” of the mood group is 0. “g” refers to a coefficient for the feedback of secondary emotion from the secondary emotion generation unit 30. “g” is inversely proportional to dominance of nature of an artificial intelligence system. “g” is in the range 0<γ<0.1. “g” is determined by the “D” value among the PAD values. When the “D” value is in the range of −1 to 1, and when the “D” value is 1, “g” is 0, and when the “D” value is −1, “g” is 0.1.

“Eᵢ” refers to an accumulated value of the number of feedbacks of at least one piece of secondary emotion associated with each mood group “Mᵢ” as a result of the feedback of the secondary emotion generated by the secondary emotion generation unit 30. “Eᵢ” increases by +1 each time the secondary emotion associated with each mood group “Mᵢ” is fed back and ranges from 0 to 10. For example, when an artificial intelligence system receives praise, secondary emotion “E2₁” of pleasure is expressed, and when “E2₁” is fed back, a value of “E₁” corresponding to “E2₁” increases. When continuously receiving praise, the value of “E1” accumulates only to 10 and does not increase any more.

“cₚₑₐₖ” refers to the time when arousal of an artificial intelligence system is made to a maximum level and may be set to, for example, 2 am. “t” refers to the real time of a position where an artificial intelligence system is placed. Since “Mᵢ(t) “is the basis of secondary emotion, the gain of each value has to be set so as not to exceed a specific value between 0 and 1, for example, Mᵢ(t)<0.5.

In this way, the basic emotion generation unit 20 models the selected mood group by calculating intensity of the selected mood group based on a plurality of values determined according to the external background feeling of the external environment information recognized by the environment recognizer 11 of the external information recognition unit 10, PAD values indicating the nature of an artificial intelligence system, and an accumulated value of the number of feedbacks of at least one piece of secondary emotion associated with the selected mood group. The mood of an artificial intelligence system is shifted in response to external environmental stimulus, such as weather and time, and is affected by temperamental factors, such as nature, and is also affected by the secondary emotion of the artificial intelligence system.

In step 24, the secondary emotion generation unit 30 generates secondary emotion based on external information recognized by the external information recognition unit 10 in step 21, the mood generated by the basic emotion generation unit 20 in step 23, social norm of the preset artificial intelligence system, and details of the previous task generated by the task generation unit 50 in step 26. The social norm of an artificial intelligence system is information on whether the social norm is socially and ethically appropriate, and unlike the unique nature of each artificial intelligence system, the same social norm is applied to multiple artificial intelligence systems and is stored in the storage 70. When step 21 to step 27 illustrated in FIG. 2 are performed first, there is no previous task generated by the task generation unit 50, and accordingly, the secondary emotion generation unit 30 generates secondary emotion based on the external information recognized by the external information recognition unit 10 in step 21, the mood generated by the basic emotion generation unit 20 in step 23, and social norm of the preset artificial intelligence system.

FIG. 4 is a table showing factors that affect generation of secondary emotion by the secondary emotion generation unit 30 illustrated in FIG. 1. The secondary emotion of the artificial intelligence system may be defined as discrete emotion generated based on an appraisal theory of emotion. The secondary emotion of the present embodiment is defined as discrete emotion and neutral emotion of eight types of “Robert Plutchik” as illustrated in FIG. 4. According to the secondary emotion of the present embodiment, intensity of discrete emotion of a specific type increases according to a specific cognitive stimulus and returns to a stable state over time. Mood provides a basement for return to a stable state of each discrete emotion, and shift of each secondary discrete emotion occurs after the shift of mood. After the shift of secondary emotion, the secondary emotion provides feedback on the mood of a system.

The secondary emotion generation unit 30 evaluates intention and context of a user for an artificial intelligence system regarding a user's action indicating the user's emotional state recognized by the emotion recognizer 12 of the external information recognition unit 10 and a user's action indicating the user's intention recognized by the intention recognizer 13, according to the table shown in FIG. 4. The secondary emotion has characteristics of shifting to neutral emotion over time.

The secondary emotion generation unit 30 evaluates a user's context based on a user's action indicating the user's emotional state recognized by the emotion recognizer 12 of the external information recognition unit 10, a user's action indicating the user's intention recognized by the intention recognizer 13, and relevance of a previous task generated by the task generation unit 50. For example, although an artificial intelligence system has not done anything worthy of comfort, sympathy, or apology, when a user's intention of speech is comfort, sympathy, or apology, “trust”, which is the corresponding emotion, is not generated. Context evaluation of a user may be made based on an Ortony, Clore, and Collins (OCC) evaluation model.

The secondary emotion generation unit 30 checks whether the case corresponding to “o” and “x” in Table 4 meets the social norm stored in the storage 70, checks the relevance of the previous task generated by the task generation unit 50, and increases intensity of emotion of the corresponding type. When the case of “o” in Table 4 meets the social norm or is related to the previous task, the intensity of emotion of the corresponding type increases. When the case of “x” in Table 4 violates the social norm or is not related to the previous task, the intensity of emotion of the corresponding type increases.

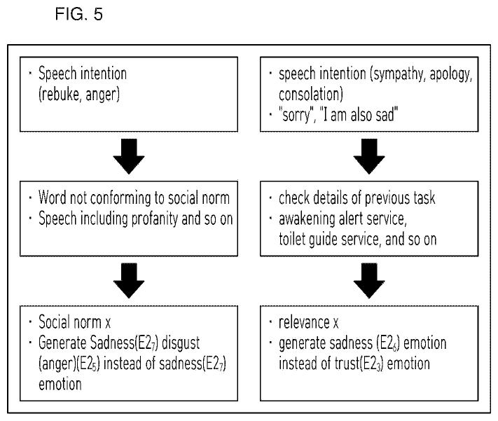

In the case of “−” in Table 4, the secondary emotion generation unit 30 does not check whether to meet the social norm and relevance of the previous task. For example, when a user speaks “thank you for helping me” with a smiling expression, the emotion “E2₁” of pleasure is basically generated. However, when the speech “thank you for helping me” does not meet the social norm, for example, when the speech includes profanity, the corresponding emotion is not generated. FIG. 5 illustrates examples of generating secondary emotion by using the secondary emotion generation unit 30 illustrated in FIG. 1.

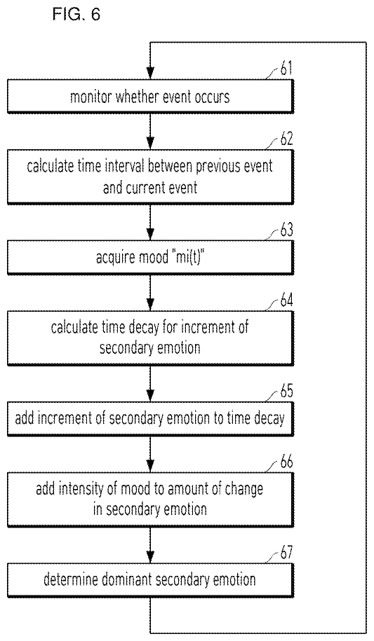

FIG. 6 is a flowchart of a secondary emotion generation process by the secondary emotion generation unit 30 illustrated in FIG. 1. Referring to FIG. 6, the secondary emotion generation process of the secondary emotion generation unit 30 includes following steps. The secondary emotion generation process of the secondary emotion generation unit 30 is premised on the existence of “ÑE2ᵢ(t−1)” and “Mᵢ(t−1)”. Here, “t−1” is a symbol indicating the time of occurrence of a previous event.

The secondary emotion generation unit 30 calculates intensity of secondary emotion of each type based on an increment of secondary emotion of at least one type generated according to the result of suitability evaluation of an action of a user on the social norm of an artificial intelligence system and relevance evaluation of the action of the user on a previous task and based on intensity of each mood group that matches the secondary emotion of each type among intensities of the moods generated in step 23, and generates secondary emotion by determining the secondary emotion with the highest intensity among secondary emotions of multiple types as the secondary emotion of the artificial intelligence system. A secondary emotion generation method will be described below in detail.

In step 61, the secondary emotion generation unit 30 periodically checks an action of a user indicating an emotional state of the user recognized by the emotion recognizer 12 of the external information recognition unit 10 and intention of the user recognized by the intention recognizer 13 to monitor whether an event corresponding to occurrence of at least one type of secondary emotion among eight types of secondary emotion in the table illustrated in FIG. 4 occurs. When an event occurs as a result of monitoring in step 61, the process proceeds to step 62. Hereinafter, the secondary emotion generation process of the secondary emotion generation unit 30 will be described assuming that an event such as praise or gratitude occurs at time “t”. The event occurring at the time “t” is referred to as a “k event”.

In step 62, the secondary emotion generation unit 30 calculates a time interval between a previous event and a current event in seconds according to Equation 4 below. In Equation 4, “t” is a symbol indicating occurrence time of the current event, and “t−1” is a symbol indicating occurrence time of the previous event.

$$∇ T = t - ( t - 1 ) \qquad Equation 4$$

In step 63, the secondary emotion generation unit 30 acquires mood “Mᵢ(t)” generated at the time “t” from the basic emotion generation unit 20.

In step 64, the secondary emotion generation unit 30 calculates time decay for an increment of at least one piece of existing secondary emotion previously generated by using a time interval generated in step 62 according to Equation 5 below. In Equation 5, “αᵢ” uses the “A” value among the PAD values indicating the nature of an artificial intelligence system.

$$∇ E {2}_{i} ( t ) = ∇ E {2}_{i} ( t - 1 ) - {α}_{i} \cdot ∇ T , ( if ∇ E {2}_{i} ( t ) < 0 , ∇ E {2}_{i} ( t ) = 0 ) \qquad Equation 5$$

In step 65, the secondary emotion generation unit 30 calculates the amount of change in the secondary emotion by adding an increment of secondary emotion to time attenuation calculated in step 64 for the secondary emotion of the type corresponding to the k event that occurs at the time “t”. The secondary emotion generation unit 30 calculates an increment of secondary emotion according to the k event by using Equation 6 below. In Equation 6, “Dₖ” indicates the increment of emotion generated according to the table illustrated in FIG. 4 and is in the range of Dₖ<0.5. When secondary emotion “E2ᵢ” satisfying the condition of “o” or ‘x’ in the table illustrated in FIG. 4 occurs, “Dₖ” is the secondary emotion “E2ᵢ” occurring in this way. When neutral secondary emotion “E2₉” occurs, “Dₖ” in all “ÑE2ᵢ₌ₖ(t)” is 0.

$$∇ E {2}_{i = k} ( t ) = ∇ E {2}_{i = k} ( t ) + {Δ}_{k} , ( if ∇ E {2}_{i = k} ( t ) > 1 , ∇ E {2}_{i = k} ( t ) = 1 ) \qquad Equation 6$$

The secondary emotion generation unit 30 does not add an increment to the secondary emotion of a type that does not correspond to the k event in the table illustrated in FIG. 4, according to Equation 7 below. That is, for the secondary emotion of the type that does not correspond to the k event, the secondary emotion generation unit 30 determines the time attenuation calculated in step 64 as the amount of change in the secondary emotion of the type.

$$∇ E {2}_{i \neq k} ( t ) = ∇ E {2}_{i \neq k} ( t ) \qquad Equation 7$$

In step 66, the secondary emotion generation unit 30 calculates intensity of secondary emotion of each type by adding the intensity of mood matching the secondary emotion of each type among the mood “Mᵢ(t)” in step 63 to the amount of change in secondary emotion of each type calculated in step 66 according to Equation 8 below. M₁ (pleasure, anticipation, and trust) matches E2₁, E2₂, and E2₃, M₂ (anger and fury) matches E2₄ and E2₅, M₅ (surprise) matches E2₆, M₇ (sadness) matches E2₇, and M₆ (fear) matches E2₈.

$$E {2}_{i} ( t ) = {M}_{i , matching} ( t ) + ∇ E {2}_{i} ( t ) , ( if E {2}_{i} ( t ) > 1. , then E {2}_{i} ( t ) = 1. ) \qquad Equation 8$$

In step 67, the secondary emotion generation unit 30 selects dominant secondary emotion among nine types of secondary emotion including neutral emotion based on intensities of eight types of secondary emotion calculated in step 66 according to Equation 9 below, and determines the dominant secondary emotion selected in this way as the secondary emotion of an artificial intelligence system. In Equation 9, “E2ₜₕ” indicates a threshold intensity of the secondary emotion, for example, 0.6. That is, when at least one of the eight types of secondary emotion calculated in step 66 has a high threshold intensity, the secondary emotion generation unit 30 selects the type of secondary emotion with the highest intensity as the dominant secondary emotion. When all the eight types of secondary emotion calculated in step 66 are less than the threshold intensity, the neutral emotion is selected as the dominant secondary emotion.

$$if E {2}_{i} ( t ) > E {2}_{th} and E {2}_{i} ( t ) > any E {2}_{j} ( t ) , then Dominant E 2 ( t ) = E {2}_{i} ( t ) \\ if all E {2}_{i} ( t ) < E {2}_{th} , then Dominant E 2 ( t ) = “ neutral ” \qquad Equation 9$$

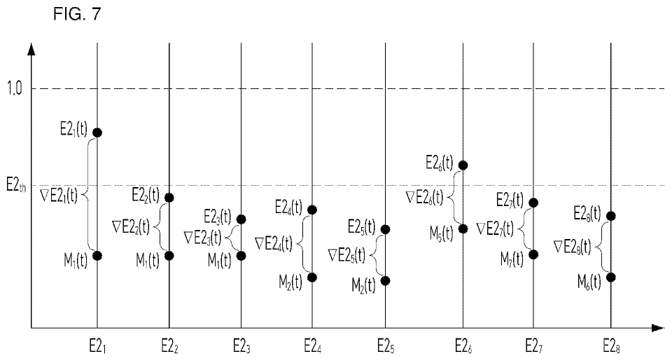

When step 67 is performed, the process returns to step 61, and the secondary emotion generation unit 30 monitors whether an event corresponding to each type of secondary emotion occurs. FIG. 7 is an example diagram of a secondary emotion model generated according to the secondary emotion generation process illustrated in FIG. 6. According to the example illustrated in FIG. 7, among the eight types of secondary emotion calculated in step 66, “E2₁(t)” is determined as dominant emotion.

In step 25, the action tendency generation unit 40 generates an action tendency of an artificial intelligence system based on the secondary emotion generated by the secondary emotion generation unit 30 in step 24 and the preset action goal of the artificial intelligence system. The action tendency of the artificial intelligence system is a discrete action tendency indicating either cooperation or rejection, and suggests a direction of action decision of the artificial intelligence system. When the artificial intelligence system of the present embodiment is an artificial intelligence system for providing a certain service in a relationship with a user, the action goal of the artificial intelligence system is set as a cooperative relationship with the user and stored in the storage 70.

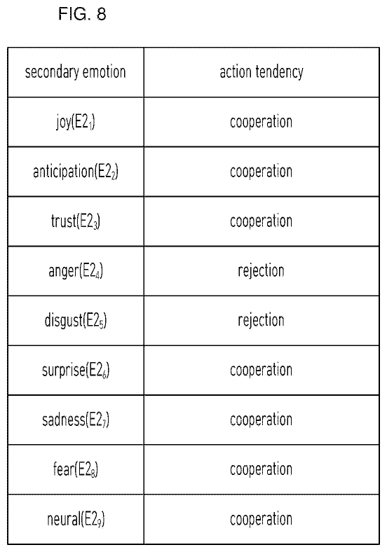

When the action goal of the artificial intelligence system is set as a cooperative relationship with the user, FIG. 8 is a table showing a correspondence between secondary emotion and an action tendency of the artificial intelligence system. As illustrated in FIG. 8, the action tendency generation unit 40 selects any one action tendency among a plurality of action tendencies, for example, cooperation and rejection based on the secondary emotion generated by the secondary emotion generation unit 30 in step 24 and the action goal of the artificial intelligence system, thereby generating an action tendency of an artificial intelligence system.

In step 26, the task generation unit 50 generates at least one task based on the secondary emotion generated by the secondary emotion generation unit 30 in step 24 and the action tendency generated by the action tendency generation unit 40 in step 25. The task generated by the task generation unit 50 is an action plan of a robot or an artificial human and includes, for example, a facial expression plan, a gesture expression plan, a speech text expression plan, and so on of a robot or an artificial human. The task generation unit 50 may be implemented by using a belief desire intention (BDI) model. For example, when a user asks a robot with a happy expression, “Robot, come here” and when the robot decides to accept this as “cooperation”, the task generation unit 50 may generate a response phrase of cooperation “All right”.

In step 27, the action expression unit 60 expresses an action of an artificial intelligence system by performing at least one task generated by the task generation unit 50 in step 26. For example, the action expression unit 60 may express an action of an intelligent system by controlling a facial expression, a gesture, and an output voice of a robot or an artificial human according to a facial expression plan, a gesture expression plan, and a speech expression plan generated by the task generation unit 50. In this way, an artificial intelligence system according to the present disclosure may enable a robot or an artificial human to make a facial expression, a gesture, or speech that corresponds to secondary emotion.

The artificial intelligence system according to the present disclosure may generate primary emotion and mood based on external information and nature data, generate secondary emotion based on the mood generated in this way, generate an action tendency based on the secondary emotion generated in this way, and thereby, enabling expressions of emotion and action to which nature and mood are reflected and performing smooth and natural interactions with people. By expressing an action according to the action tendency generated in this way, secondary emotion and action tendency are generated by considering mood even when a standard for all types of emotion is not set in advance for each individual action decision, and thus, natural action decision may be made in social relationships with multiple people.

The artificial intelligence system according to the present disclosure may immediately respond to external information that does not require cognitive evaluation, such as surprise or fear, and express an action by considering only nature and may generate secondary emotion and an action tendency on external information that requires cognitive evaluation by considering nature and mood, thereby reacting to the external information very similarly to actual human, and generating delicate emotion and expressing an action according the response to the external information.

Meanwhile, the action tendency generation method described above may be implemented by a program executable on a processor of a computer and may be implemented on a computer that records and executes the program on a computer-readable recording medium. The computer includes all types of computers that may execute programs, such as a desktop computer, a notebook computer, a smartphone, and an embedded-type computer. In addition, a structure of the data used in one embodiment of the present disclosure described above may be recorded on a computer-readable recording medium through various means. The computer-readable recording medium includes a storage, such as random access memory (RAM), read only memory (ROM), a magnetic storage medium (for example, a floppy disk, a hard disk, or so on), or an optical reading medium (for example, compact disk (CD)-ROM, a digital video disk (DVD), or so on).

Herein, preferred embodiments of the present disclosure are described. Those skilled in the art to which the present disclosure belongs will be able to understand that the present disclosure may be implemented in a modified form without departing from the essential characteristics of the present disclosure. Therefore, the disclosed embodiments should be considered from an illustrative point of view rather than a restrictive point of view. The scope of the present disclosure is represented in the claims rather than the above description, and all differences within the equivalent scope will be construed as being included in the present disclosure.

What is claimed is:

1. An artificial intelligence system that generates an action tendency by considering emotion and mood according to recognition of external information, the artificial intelligence system comprising:
an external information recognition unit configured to recognize external information of the artificial intelligence system;
a basic emotion generation unit configured to generates primary emotion and mood based on the recognized external information and a preset nature data of the artificial intelligence system;
a secondary emotion generation unit configured to generate secondary emotion based on the generated mood; and
an action tendency generation unit configured to generate action tendency for suggesting a direction of action decision of the artificial intelligence system based on the generated secondary emotion.

2. The artificial intelligence system of claim 1, wherein
the basic emotion generation unit generates the mood by modeling one mood group among a plurality of mood groups based on the recognized external information and pleasure arousal dominance (PAD) values indicating nature of the artificial intelligence system.

3. The artificial intelligence system of claim 2, wherein
the secondary emotion generation unit generates the secondary emotion based on the recognized external information, the generated mood, and a preset social norm of the artificial intelligence system.

4. The artificial intelligence system of claim 3, wherein
the secondary emotion generation unit calculates intensity of secondary emotion of each type based on an increment of at least one type of secondary emotion generated according to a suitability evaluation result of an action of a user for the preset social norm and intensity of each mood group matching the secondary emotion of each type among intensities of the generated mood, and generates the secondary emotion by determining secondary emotion of a highest intensity among a plurality of types of secondary emotion as the secondary emotion.

5. The artificial intelligence system of claim 4, further comprising:
a task generation unit configured to generate at least one task based on the action tendency generated by the action tendency generation unit,
wherein the secondary emotion generation unit calculates the intensity of the secondary emotion of each type based on an increment of at least one type of secondary emotion generated according to the suitability evaluation result of the action of the user for the preset social norm and relevance evaluation of the action of the user for the generated task and based on the intensity of each mood group matching the secondary emotion of each type among the intensities of the generated mood, and generates the secondary emotion by determining secondary emotion of a highest intensity among a plurality of types of secondary emotion as the secondary emotion.

6. The artificial intelligence system of claim 3, wherein
the basic emotion generation unit generates the mood by modeling the one mood group among the plurality of mood groups based on external background feeling, the pleasure arousal dominance (PAD) values indicating the nature, and the generated secondary emotion among the recognized external information.

7. The artificial intelligence system of claim 6, wherein
the basic emotion generation unit selects one of the plurality of mood groups according to whether each of a “P” value, an “A” value, and a “D” value of the pleasure arousal dominance (PAD) values indicating the nature corresponds to a positive number or a negative number, and models the selected mood group based on the external background feeling of the recognized external information, the pleasure arousal dominance (PAD) values indicating the nature, and the generated secondary emotion.

8. The artificial intelligence system of claim 7, wherein
the basic emotion generation unit models the selected mood group by calculating intensity of the selected mood group based on the pleasure arousal dominance (PAD) values indicating the nature, a plurality of values determined according to the external background feeling of the recognized external information, and an accumulated value of the number of feedbacks of at least one piece of secondary emotion associated with the selected mood group.

9. The artificial intelligence system of claim 1, wherein
the basic emotion generation unit generates primary emotion by modeling at least one emotional element among a plurality of emotional elements based on external physical stimulus of the recognized external information and pleasure arousal dominance (PAD) values indicating the nature.

10. The artificial intelligence system of claim 1, wherein
the action tendency generation unit generates action tendency of the artificial intelligence system based on the generated secondary emotion and a preset action goal of the artificial intelligence system.

11. A method of generating action tendency by considering emotion and mood according to recognition of external information, the method comprising:
recognizing external information of an artificial intelligence system;
generating primary emotion and mood based on the recognized external information and a preset nature data of the artificial intelligence system;
generating secondary emotion based on the generated mood; and
generating action tendency for suggesting a direction of action decision of the artificial intelligence system based on the generated secondary emotion.

12. A computer-readable recording medium in which a program for causing a computer to perform the method of claim 1 is recorded.
